(19) United States
(12) Patent Application Publication
(10) Pub. No.: US 2024/0215121 A1
(43) Pub. Date: Jun. 27, 2024

(54) INDUCTION ENERGY SUPPLY DEVICE

(71) Applicant: BSH Hausgeräte GmbH, Munich (DE)

(72) Inventors: Javier Lasobras Bernad, EJEA DE LOS CABALLEROS (ZARAGOZA) (ES); Sergio Llorente Gil, Zaragoza (ES); Jesus Manuel Moya Nogues, Zaragoza (ES); Jorge Pascual Aza, Zaragoza (ES); Javier Serrano Trullen, Zaragoza (ES); Jorge Tesa Betes, Zaragoza (ES)

(21) Appl. No.: 18/288,389

(22) PCT Filed: Apr. 27, 2022
(86) PCT No.: PCT/EP2022/061134

§ 371 Date: Oct. 26, 2023

(30) Foreign Application Priority Data
May 3, 2021 (EP) 21382393

(51) Int. Cl. H05B 6/06; H02M 1/34; H02M 7/537; H05B 6/12

(52) U.S. Cl. CPC H05B 6/062; H02M 1/34; H02M 7/537; H05B 6/1236; H05B 2213/06

(57) ABSTRACT

An induction energy supply device includes a supply unit having a supplying induction element designed to inductively provide energy to a positioned unit, an inverter unit designed to operate the supplying induction element, a snubber unit interacting with the inverter unit and including a plurality of snubber capacitors, and a control unit designed to control the inverter unit and including a data reception element for wireless reception of an operating parameter from the positioned unit. The control unit is designed to adjust a setting of the snubber unit on the basis of the operating parameter.

The invention relates to an induction energy supply device according to the preamble of claim 1, an induction energy transmission system according to claim 10 and a method for operating an induction energy supply device according to the preamble of claim 13.

Induction energy supply devices are already known from the prior art for the inductive transmission of energy from a primary coil of a supply unit to a secondary coil of a positioned unit. An induction cooktop is proposed in the publication U.S. Pat. No. 3,761,668 A, for example, the induction cooktop being provided for supplying energy to small household appliances, for example a blender, in addition to inductively heating an item of cookware. Energy which is inductively provided by a primary coil of the induction cooktop is partially transmitted to a secondary coil integrated in the small household appliance.

In the known manner, various positioned units, in particular different types of small household appliances, can have significant differences in their respective power requirements. Depending on the required power of the positioned unit, a switching frequency of inverters has to be varied for operating the supply unit, wherein the extent of the switching losses of the inverters occurring during operation, in addition to the switching frequency itself, is also dependent, in particular, on a configuration of the snubber capacitors connected to the inverters. Thus very high switching losses occur in hitherto known induction energy supply devices, in the case of operating positioned units with a low power requirement of up to 500 watts, so that only very low energy efficiency can be achieved thereby, which is disadvantageous. In addition, many known induction energy supply devices, for example conventional induction cooktops, permit an operation of the positioned units only in a very limited power range due to the fixed configuration of the snubber capacitors. This is because specific switching frequencies cannot be exceeded or fallen below due to the configuration of the snubber capacitors, since the snubber capacitors are otherwise not fully charged or discharged during a switching cycle.

As a result, a flexibility regarding an operation of different positioned units is significantly limited in the hitherto known induction energy supply devices, which is disadvantageous.

The object of the invention, in particular but not limited thereto, is to provide a generic device having improved properties regarding an efficiency. The object is achieved according to the invention by the features of claims 1, 10 and 13, while advantageous embodiments and developments of the invention can be found in the dependent claims.

The invention is based on an induction energy supply device comprising a supply unit that includes at least one supplying induction element for inductively providing energy to a positioned unit, further comprising an inverter unit for operating the supplying induction element, also comprising a snubber unit which is allocated to the inverter unit and includes a plurality of snubber capacitors, and comprising a control unit for controlling the inverter unit.

It is proposed that the control unit includes a data reception element for wireless reception of at least one operating parameter from the positioned unit and is intended to adjust a setting of the snubber unit on the basis of the operating parameter.

An induction energy supply device can be advantageously provided with a particularly high level of efficiency by means of such an embodiment. In particular, an energy efficiency can be advantageously increased by the switching losses occurring in the inverter unit being able to be reduced, preferably minimized, by setting the snubber unit on the basis of the operating parameter. Additionally, a flexibility can be advantageously increased by a particularly efficient operation of very different positioned units with respectively variable power requirements. In particular, it is possible to operate positioned units with low power requirements in the range of a few hundred watts in a particularly efficient manner, which was hitherto not possible with induction energy supply devices known from the prior art. Moreover, the case of use can be advantageously improved for users since the operating parameter can be wirelessly received by the data reception element and the control unit can automatically adjust the setting of the snubber unit on the basis of the operating parameter, so that manual settings by the user are advantageously dispensed with.

The induction energy supply device has at least one main functionality in the form of a wireless energy transmission, in particular a wireless energy supply of the positioned units. The induction energy supply device can be configured as a part of an induction energy supply system. In an advantageous embodiment, the induction energy supply device is configured as an induction cooking device with at least one further main function deviating from a pure cooking function, in particular at least an energy supply and an operation of small household appliances. For example, the induction energy supply device could be configured as an induction oven device and/or as an induction grill device. In particular, the supply unit could be configured as part of an induction oven and/or part of an induction grill. Preferably, the induction energy supply device which is configured as an induction cooking device is configured as an induction cooktop. The supply unit is thus configured, in particular, as part of an induction cooktop. In a further advantageous embodiment, the induction energy supply device is configured as a kitchen energy supply device and, in addition to a main function in the form of an energy supply and an operation of small household appliances, can also be designed to provide cooking functions.

A “supply unit” is intended to be understood to mean a unit which in at least one operating state inductively provides energy and which, in particular, has a main functionality in the form of providing energy. For providing energy, the supply unit has at least one supplying induction element which, in particular, has at least one coil, in particular at least one primary coil, and/or is configured as a coil and which inductively provides energy, in particular in the operating state. The supply unit could have at least two, in particular at least three, advantageously at least four, particularly advantageously at least five, preferably at least eight and particularly preferably a plurality of supplying induction elements which in the operating state could respectively inductively provide energy and namely, in particular, to a single receiving induction element or to at least two or more receiving induction elements of at least one positioned unit and/or at least one further positioned unit. At least some of the supplying induction elements could be arranged in the vicinity of one another, for example in a row and/or in the form of a matrix.

A “positioned unit” is intended to be understood to mean a unit which in at least one operating state inductively receives energy and converts the inductively received energy at least partially into at least one further energy form for providing at least one main function. For example, the energy inductively received by the positioned unit could be converted in the operating state, in particular directly, into at least one further form of energy, such as for example into heat. Alternatively or additionally, the positioned unit could have at least one electrical consumer, for example an electric motor or the like. The positioned unit has at least one receiving induction element for receiving the inductively provided energy. The positioned unit could have, for example, at least two, in particular at least three, advantageously at least four, particularly advantageously at least five, preferably at least eight and particularly preferably a plurality of receiving induction elements which, in particular, in the operating state in each case could receive energy inductively, in particular from the supplying induction element. The positioned unit could be configured, for example, as an item of cookware. The item of cookware preferably has at least one food receiving space and in the operating state converts the inductively received energy at least partially into heat for heating food arranged in the food receiving space. Preferably, the positioned unit which is configured as an item of cookware has at least one further unit for providing at least one further function which goes beyond a pure heating of food and/or deviates from the heating of food. For example, the further unit could be configured as a temperature sensor or as a blender unit or the like. Alternatively, the positioned unit could be configured as a small household appliance. Preferably, the small household appliance is a location-independent household appliance which has at least the receiving induction element and at least one functional unit which provides at least one household appliance function in an operating state. “Location-independent” is intended to be understood to mean in this context that the small household appliance can be freely positioned in a household by a user and, in particular, without the use of tools, in particular in contrast to a large household appliance which is fixedly positioned and/or installed at a specific position in a household, such as for example an oven or a refrigerator. Preferably, the small household appliance is configured as a small kitchen appliance and in the operating state provides at least one main function for processing food. The small household appliance could be configured, for example, without being limited thereto, as a food processor and/or as a blender and/or as an electric whisk and/or as a grinder and/or as kitchen scales or as a kettle or as a coffee machine or as a rice cooker or a milk frother or as a deep-fat fryer or as a toaster or as a juicer or as a food slicer or the like.

The receiving induction element of the positioned unit comprises at least one secondary coil and/or is configured as a secondary coil. In an operating state of the positioned unit, the receiving induction element supplies at least one consumer of the positioned unit with electrical energy. Moreover, it is conceivable that the positioned unit has an energy storage device, in particular an accumulator, which is provided in a charging state to store electrical energy received by the receiving induction element, and in a discharging state to provide the energy for supplying the functional unit.

Preferably, in the operating state the inverter unit carries out a frequency conversion and converts, in particular, a low frequency AC voltage on the input side into a high frequency AC voltage on the output side. Preferably, the low frequency AC voltage has a frequency of at most 100 Hz. Preferably, the high frequency AC voltage has a frequency of at least 1000 Hz. The inverter unit is connected to the control unit and is controllable by the control unit by means of control signals. Preferably, the inverter unit is provided to undertake the setting of the energy inductively provided by the at least one supplying induction element by setting the high frequency AC voltage. Preferably, the supply unit comprises at least one rectifier. The inverter unit has at least one inverter switching element. Preferably, for operating the at least one supplying induction element the inverter switching element generates an oscillating electrical current, preferably at a frequency of at least 15 kHz, in particular of at least 17 kHz and advantageously of at least 20 kHz. Preferably, the inverter unit has at least two inverter switching elements which are preferably configured as bipolar transistors with insulated gate electrodes and particularly advantageously at least one damping capacitor.

The snubber unit is allocated to the inverter unit and is provided to limit a voltage rise rate when switching the inverter switching elements of the inverter unit and thus to reduce, preferably to minimize, the switching losses occurring when switching the inverter switching elements. Moreover, the snubber unit is provided, in particular, to protect the inverter switching elements from excessive voltages. Moreover, the snubber unit is provided, in particular, to neutralize interfering high frequency signals and to contribute to achieving an improved electromagnetic compatibility of the induction energy supply device. The snubber unit has, in particular, the plurality of snubber capacitors and can also have further elements, for example electrical resistors and/or switches. The snubber unit has a plurality of at least two, preferably at least three and particularly preferably at least four, snubber capacitors. Each of the snubber capacitors of the snubber unit is preferably electrically conductively connected directly to at least one terminal of one of the inverter switching elements of the inverter unit. It might be conceivable that all of the snubber capacitors of the snubber unit are configured substantially identically to one another and in each case have the same electrical capacitance. Preferably, at least two of the snubber capacitors of the snubber unit are configured differently from one another and differ, in particular, regarding their respective electrical capacitance and/or design. A snubber capacitor differs from further capacitors of the induction energy supply device, in particular from a BUS capacitor and/or a resonance capacitor, which forms an electromagnetic oscillating circuit with at least one of the supplying induction elements and/or from further possibly present capacitors of the induction energy supply device, at least regarding its arrangement and function relative to at least one of the inverter switching elements of the inverter unit.

A “control unit” is intended to be understood to mean an electronic unit which is provided to control and/or regulate at least the inverter unit. Preferably, the control unit comprises a computer unit and, in particular in addition to the computer unit, a memory unit with a control and/or regulating program which is stored therein and which is provided to be executed by the computer unit.

The data reception element is preferably provided for a bi-directional wireless data transmission, i.e. both for wireless reception and wireless transmission of data. The data reception element could be provided for wireless data transmission between the positioned unit and the control unit by RFID or by WIFI or by Bluetooth or by ZigBee, or for wireless data transmission according to another suitable standard. Preferably, the data reception element is provided for a wireless reception of data by NFC, the data comprising at least the operating parameter but not having to be limited to the operating parameter. Particularly preferably, the data reception element is provided both for wireless reception and for wireless transmission of data by NFC.

The operating parameter of the positioned unit could be, for example, in particular a currently set target power and/or a minimum power and/or a maximum power of the positioned unit. It might also be conceivable that the operating parameter is a parameter which characterizes in more detail the receiving induction element of the positioned unit and which, for example, comprises a shape and/or size, in particular a radius and/or diameter, and/or a cross-sectional surface and/or a number of windings and/or a material and/or a spatial position of the receiving induction element within the positioned unit and/or a value of an electrical resistance and/or an impedance and/or an inductance and/or a magnetic flux density and/or a resonance frequency and/or the like.

Preferably, an induction energy transmission system comprising the induction energy supply device has at least one positioning plate for positioning the positioned unit. It might also be conceivable that the positioning plate is part of the induction energy supply device. A “positioning plate” is intended to be understood to mean at least one, in particular plate-like, unit which is provided for positioning at least one positioned unit and/or for positioning at least one food to be cooked. The positioning plate could be configured, for example, as a countertop, in particular as a kitchen countertop, or as a sub-region of at least one countertop, in particular of at least one kitchen countertop, in particular of the induction energy supply device. Alternatively or additionally, the positioning plate could be configured as a cooktop plate. The positioning plate which is configured as a cooktop plate could form, in particular, at least one part of a cooktop external housing and form the cooktop external housing at least to a large part, in particular, together with at least one external housing unit to which the positioning plate, which is configured as a cooktop plate, could be connected, in particular, in at least one assembled state. Preferably, the positioning plate is manufactured from a non-metallic material. The positioning plate could be formed, for example, at least to a large part from glass and/or from glass ceramic and/or from Neolith and/or from Dekton and/or from wood and/or from marble and/or from stone, in particular from natural stone, and/or from laminate and/or from plastics and/or from ceramic. In the present application, directional terms such as for example “below” or “above” refer to an assembled state of the positioning plate, provided this is not explicitly described otherwise. In the assembled state, the positioning plate is preferably arranged above the supply unit.

In the present application, numerical terms such as, for example, “first” and “second” which are placed before certain terms merely serve for differentiating objects and/or an assignment of objects to one another, and do not imply an existing total number and/or ranking of the objects. In particular, a “second object” does not necessarily imply a presence of a “first object”.

“Provided” is intended to be understood to mean specifically programmed, designed and/or equipped. An object being provided for a specific function is intended to be understood to mean that the object fulfills and/or executes this specific function in at least one use state and/or operating state.

It is further proposed that the operating parameter is a target power of the positioned unit. An efficiency can be advantageously further increased thereby. Preferably, the target power is a power which at a current time, in particular at a time of data being received by the control unit, is set in the positioned unit and is required for covering a current energy requirement of the positioned unit at the time. It might also be conceivable that the operating parameter defines a plurality of target powers, for example a first target power which defines the power required at the current time, and a second target power which defines a power required at a future time, for example after changing a power level of the positioned unit.

It is further proposed that the induction energy supply device has a measuring unit which is provided for measuring at least one further operating parameter of the positioned unit. An efficiency can be advantageously further improved thereby. The measuring unit could have at least one optical element, for example a camera and/or a light barrier or the like, which is provided for detecting the further operating parameter of the positioned unit, a shape and/or size of the positioned unit and/or a current degree of coverage of the supplying induction element by the receiving induction element. Preferably, the measuring unit is part of the control unit and is electrically conductively connected to the supply unit. Preferably, the measuring unit comprises a microprocessor. For determining the further operating parameter, in an operating state the measuring unit preferably measures at least one measuring signal of the supply unit, in particular a signal of an AC current of an oscillating circuit which is formed by the supplying induction element and at least one inverter switching element of the inverter unit. The measuring unit compares the measuring signal, in particular by means of the microprocessor, with a stored reference signal which is preferably measured in a reference state in which the supply unit has been operated without load, i.e. in particular without a receiving induction element being located above the supplying induction element and determines therefrom the further operating parameter. The further operating parameter could be a parameter which characterizes the receiving induction element of the positioned unit in more detail and which comprises, in particular, at least one electrical and/or electromagnetic variable of the receiving induction element, for example a value of an electrical resistance and/or an impedance and/or an inductance and/or a magnetic flux density and/or a resonance frequency and/or the like. Preferably, the further operating parameter is a current power loss occurring during operation of the supply unit for inductively providing energy to the positioned unit. It might also be conceivable that the further operating parameter comprises the same variable as the operating parameter. For example, the operating parameter and the further operating parameter could comprise in each case a target power of the positioned unit. As a result, it is advantageously possible for the control unit to monitor the operating parameter received from the positioned unit by the data reception element and thus a susceptibility to error of the induction energy supply device can be reduced. It is also proposed that the control unit is provided to consider the further operating parameter when setting the snubber unit. A particularly accurate adjustment of the setting of the snubber unit by the control unit can be advantageously achieved thereby and thus an efficiency further improved.

It is further proposed that at least one of the snubber capacitors of the snubber unit is configured as a variable capacitor. An efficiency can be advantageously further increased by means of such an embodiment, in particular by a particularly accurate and stepless adjustment of the setting of the snubber unit being made possible. The variable capacitor could be a mechanically variable capacitor, for example a rotary capacitor or a trimmer capacitor, in particular an SMD trimmer or a tubular trimmer or a variable vacuum capacitor, or the like. It might also be conceivable that the variable capacitor is configured as an electrically variable capacitor, for example as a variable capacitance diode or a dielectrically variable capacitor or as a digitally variable capacitor, or the like.

It is further proposed that the snubber unit has at least one switching element, by means of the switching element at least one of the snubber capacitors being able to be switched on or off by the control unit. An efficiency can be advantageously further increased thereby. In particular, a cost efficiency can be improved, since the possibility of setting the snubber unit by switching individual snubber capacitors on or off by means of the switching element can be implemented particularly simply and cost-effectively. The switching element has at least one control contact via which it can be controlled by the control unit. The switching element could be configured as a mechanical and/or electromechanical switching element, for example as a relay. Preferably, the switching element is configured as a semi-conductor switching element, in particular as a transistor. For example, the switching element could be configured as an FET, in particular as a MOSFET or as an RC-IGBT. Particularly preferably, the switching element is configured as an HEMT transistor.

It is further proposed that a total electrical capacitance of the snubber unit can be set by the control unit to at least two different levels within a value range of at least 0 nF and of at most 40 nF. A flexibility can be advantageously improved by means of such an embodiment. In particular, the total electrical capacitance of the snubber unit can be set by the control unit to at least two different levels within a value range of at least 1 nF. advantageously of at least 2 nF, particularly advantageously of at least 3 nF, preferably of at least 4 nF, particularly preferably of at least 5 nF and of at most 39 nF, advantageously of at most 37 nF, particularly advantageously of at most 35 nF, preferably of at most 34 nF, particularly preferably of at most 33 nF.

It is further proposed that, in a first level of the two levels, the total electrical capacitance of the snubber unit has a value of at least 0 nF and of at most 20 nF. An efficiency can be advantageously further improved by means of such an embodiment. In particular, it is possible to achieve a very efficient operation of the inverter unit for inductively providing energy by the supplying induction element to positioned units with a low power requirement, in particular a power requirement of up to 500 watts. In particular, in the first level the total electrical capacitance of the snubber unit has a value of at least 1 nF. advantageously of at least 2 nF, particularly advantageously of at least 3 nF, preferably of at least 4 nF, particularly preferably of at least 5 nF, and of at most 19 nF, advantageously of at most 18 nF. particularly advantageously of at most 17 nF, preferably of at most 16 nF and particularly preferably of at most 15 nF.

It is further proposed that, in a second level of the two levels, the total electrical capacitance of the snubber unit has a value of at least 15 nF and of at most 40 nF. An efficiency can be advantageously further improved thereby. In particular, it is possible to achieve a very efficient operation of the inverter unit for the inductive provision of energy by the supplying induction element to positioned units with a medium to high power requirement, in particular a power requirement of 500 watts or more. In particular, in the second level the total electrical capacitance of the snubber unit has a value of at least 16 nF. advantageously of at least 17 nF. particularly advantageously of at least 18 nF. preferably of at least 19 nF, particularly preferably of at least 20 nF, and of at most 39 nF, advantageously of at most 37 nF, particularly advantageously of at most 35 nF, preferably of at most 34 nF and particularly preferably of at most 33 nF.

The invention further relates to an induction energy transmission system comprising an induction energy supply device according to one of the above-described embodiments comprising at least one positioned unit and, in particular, comprising a positioning plate arranged above the supply unit for positioning the positioned unit. Such an induction energy transmission system is characterized, amongst other things, by a particularly high level of efficiency which can be achieved, in particular, by the above-described embodiments of the induction energy supply device. Moreover, by means of such an induction energy transmission system a particularly high level of flexibility and ease of use can also be advantageously achieved for users, by a particularly efficient and at the same time simpler and more intuitive operation being made possible of different types of positioned units of the induction energy transmission system, respectively with different power requirements.

In an advantageous embodiment of the induction energy transmission system, it is proposed that the positioned unit is configured as a small household appliance. A flexibility can be advantageously further improved thereby.

In a further advantageous embodiment, it is proposed that the induction energy transmission system comprises at least one further positioned unit which is configured as an item of cookware. An ease of use can be advantageously further improved thereby. In particular, it is possible to provide an accurate control of an energy inductively provided by the supply unit for heating food arranged in the item of cookware.

The invention further relates to a method for operating an induction energy supply device, in particular according to one of the above-described embodiments, comprising a supply unit that includes at least one supplying induction element for inductively providing energy to a positioned unit, further comprising an inverter unit for operating the supplying induction element and also comprising a snubber unit which is allocated to the inverter unit and includes a plurality of snubber capacitors.

It is proposed that in an operating state at least one operating parameter of the positioned unit is wirelessly received by a data reception element and a setting of the snubber unit is adjusted on the basis of the operating parameter. A particularly efficient operation of the induction energy supply device can be advantageously made possible by means of such a method.

The induction energy supply device and the induction energy transmission system are not intended to be limited to the above-described uses and embodiments. In particular, the induction energy supply device and/or the induction energy transmission system can have a number of individual elements, components and units deviating from a number cited herein for fulfilling a mode of operation described herein.

Further advantages are found in the following description of the drawing. Exemplary embodiments of the invention are shown in the drawing. The drawing, the description and the claims contain numerous features in combination. The person skilled in the art will also expediently consider the features individually and combine them to form further meaningful combinations.

In the drawing:

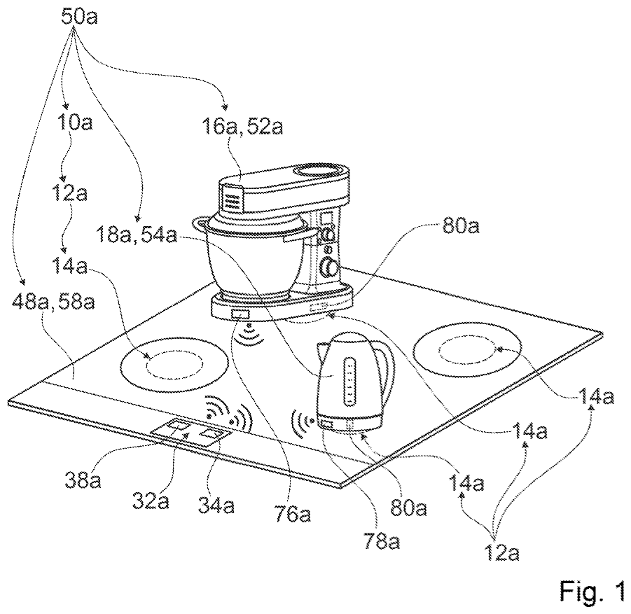

FIG. 1 shows an induction energy transmission system with an induction energy supply device which comprises a supply unit and a control unit, and with two positioned units in a schematic view,

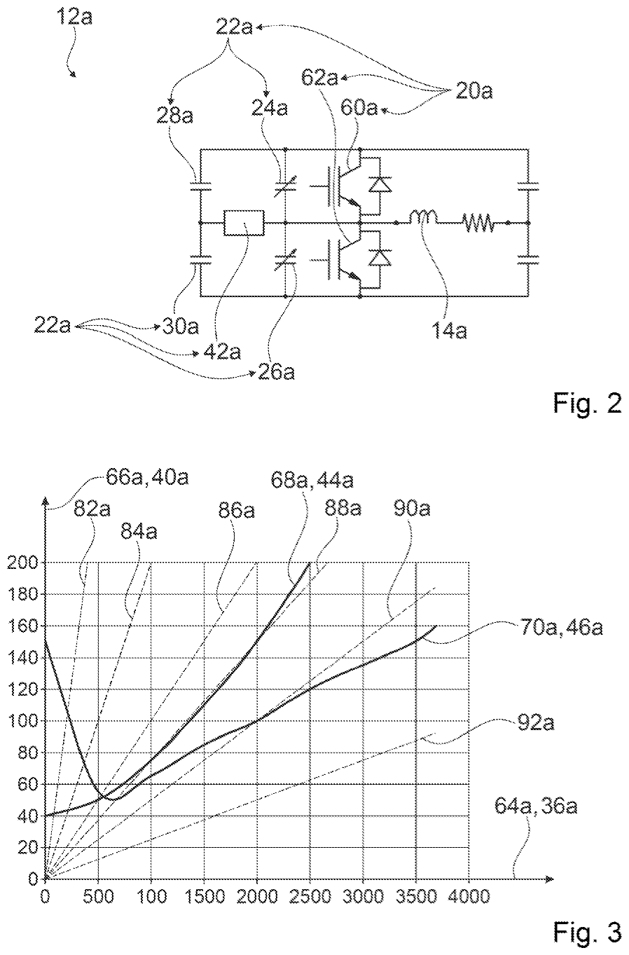

FIG. 2 shows a schematic electrical circuit diagram of the supply unit with an inverter unit and a snubber unit allocated to the inverter unit,

FIG. 3 shows a schematic diagram for illustrating two power curves of a power which can be inductively provided by the supply unit as a function of a setting of the snubber unit by the control unit,

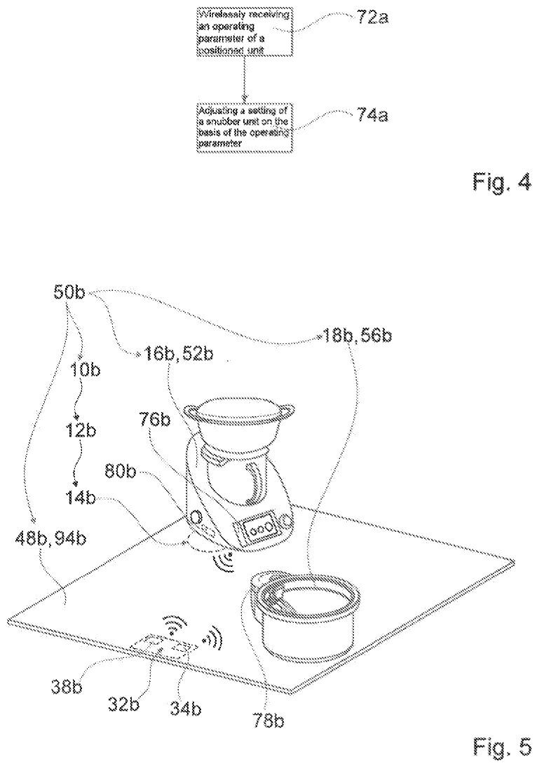

FIG. 4 shows a schematic diagram for illustrating a method for operating the induction energy supply device and

FIG. 5 shows a further exemplary embodiment of an induction energy transmission system with an induction energy supply device which comprises a supply unit and a control unit, and with two positioned units in a schematic view.

FIG. 1 shows an induction energy transmission system 50a in a schematic view. The induction energy transmission system 50a has an induction energy supply device 10a.

The induction energy transmission system 50a has at least one positioned unit 16a. In the present case, the induction energy transmission system 50a has the positioned unit 16a and a further positioned unit 18a. The positioned unit 16a is configured in the present case as a small household appliance 52a and namely as a food processor. The further positioned unit 18a is configured in the present case as a further small household appliance 54a and namely as a kettle.

The induction energy transmission system 50a has a positioning plate 48a. In the present exemplary embodiment, the positioning plate 48a is configured as a cooktop plate 58a.

The induction energy supply device 10a has a supply unit 12a. The supply unit 12a has at least one supplying induction element 14a for inductively providing energy to the positioned unit 16a and/or the further positioned unit 18a. In the present case, the supply unit 12a has a total of four supplying induction elements 14a, wherein any other number might be conceivable.

The positioned unit 16a and the further positioned unit 18a have in each case a receiving induction element 80a, which are provided for receiving at least one part of the energy provided inductively by the supplying induction element 14a.

The induction energy supply device 10a has an inverter unit 20a (see FIG. 2). The induction energy supply device 10a has a control unit 32a for controlling the inverter unit 20a.

The control unit 32a has a data reception element 34a. The data reception element 34a is provided for the wireless reception of at least one operating parameter 36a from the positioned unit 16a (see FIG. 3). In the present case, the data reception element 34a is configured as an NFC element and provided both for a wireless reception of data and also for a wireless transmission of data. The positioned unit 16a has a data transmission element 76a for a wireless transmission and reception of data. Equally the further positioned unit 18a has a further data transmission element 78a for a wireless transmission and reception of data. The data transmission element 76a and the further data transmission element 78a are respectively configured in the present case as NFC elements. In at least one operating state of the induction energy transmission system 50a, the positioned unit 16a transmits the operating parameter 36a to the data reception element 34a of the control unit 32a.

FIG. 2 shows a schematic electrical circuit diagram with the supply unit 12a. The inverter unit 20a has in the present case at least two inverter switching elements 60a, 62a for operating the supplying induction element 14a. The inverter switching elements 60a, 62a are configured in the present case as bipolar transistors with insulated gate electrodes (IGBT) and arranged in a half-bridge circuit. In an operating state, the inverter switching elements 60a, 62a provide a high frequency AC current to the supplying induction element 14a for inductively providing energy.

The induction energy supply device 10a has a snubber unit 22a. The snubber unit 22a is allocated to the inverter unit 20a. The snubber unit 22a has a plurality of snubber capacitors 24a, 26a, 28a, 30a. In the present case, the snubber unit 22a has a total of four snubber capacitors 24a, 26a, 28a, 30a, wherein any number greater than one might be conceivable.

The control unit 32a is intended to adjust a setting of the snubber unit 22a on the basis of the operating parameter 36a.

The induction energy supply device 10a has a measuring unit 38a (see FIG. 1). The measuring unit 38a is provided for determining at least one further operating parameter 40a of the positioned unit 16a. In the present case, the measuring unit 38a is part of the control unit 32a and electrically conductively connected to the supply unit 12a. The measuring unit 38a comprises a microprocessor (not shown). In an operating state, the measuring unit 38a measures at least one measuring signal of an AC current in an oscillating circuit which is formed by the supplying induction element 14a and the inverter switching elements 60a, 62a. The measuring unit 38a compares the measuring signal with a stored reference signal and determines therefrom the further operating parameter 40a. The reference signal is measured in a reference state in which the supply unit 12a is operated without load, i.e. without a receiving induction element 80a located above the supplying induction element 14a. As soon as the receiving induction element 80a is arranged above the supplying induction element 14a, the measuring signal deviates from the reference signal. The further operating parameter 40a in the present case is a power loss of the supply unit 20a (see FIG. 3).

The control unit 32a is provided to consider the further operating parameter 40a when setting the snubber unit 22a.

At least one of the snubber capacitors 24a, 26a, 28a, 30a is configured as a variable capacitor. In the present case, the snubber capacitor 24a and the snubber capacitor 26a are configured in each case as variable capacitors and namely as rotary capacitors, wherein alternatively other types of variable capacitors could be used.

The snubber unit 22a has at least one switching element 42a. By means of the switching element 42a at least one of the snubber capacitors 24a, 26a, 28a, 30a can be switched on or off by the control unit 32a. In the present case, the snubber unit 22a has exactly one switching element 42a, wherein any other number might be conceivable. By means of the switching element 42a, in the present case two of the snubber capacitors 24a. 26a, 28a, 30a, and namely the snubber capacitor 28a and the snubber capacitor 30a, can be switched on or off by the control unit 32a.

A total electrical capacitance of the snubber unit 22a can be set by the control unit 32a to at least two different levels 44a, 46a within a value range of at least 0 nF and of at most 40 nF (see FIG. 3). A first level 44a of the at least two different levels 44a, 46a corresponds to an open state of the switching element 42a. In the open state, the snubber capacitor 24a and the snubber capacitor 26a are electrically conductively connected to the inverter switching elements 60a, 62a, while the snubber capacitor 28a and the snubber capacitor 30a are not electrically conductively connected to the inverter switching elements 60a, 62a. In the first level 44a of the two levels 44a, 46a, the total electrical capacitance of the snubber unit 22a has a value of as least 0 nF and of at most 20 nF. A second level 46a of the at least two different levels 44a, 46a corresponds to a closed state of the switching element 42a. In the closed state, all of the snubber capacitors 24a, 26a, 28a, 30a of the snubber unit 22a are electrically conductively connected to the inverter switching elements 60a, 62a. In the second level 44a of the two levels 44a, 46a, the total electrical capacitance of the snubber unit 22a has a value of at least 15 nF and of at most 40 nF.

FIG. 3 shows a schematic diagram for illustrating a power which can be inductively provided by the supply unit 12a as a function of the control unit 32a setting the snubber unit 22a on the basis of the operating parameter 36a of the positioned unit 16a. A target power of the positioned unit 16a is plotted in watts on an x-axis 64a of the diagram.

The control unit 32a is intended to adjust a setting of the snubber unit 22a on the basis of the operating parameter 36a. In the present case, the operating parameter 36a is the target power of the positioned unit 16a. The power loss of the inverter unit 20a is plotted in watts on a y-axis 66a. A first power curve 68a shows a progression of the power loss as a function of the target power when the snubber unit 22a is set in the first level 44a. A second power curve 70a shows a progression of the power loss as a function of the target power when the snubber unit 22a is set in the second level 46a. The progressions of the power curves 68a, 70a are progressions which have been measured under ideal conditions. If the power loss which is measured by the measuring unit 38a in the operating state as a further operating parameter 40a deviates from the theoretical power loss according to the power curves 68a, 70a, the control unit 32a adjusts the setting of the snubber unit 22a further and, in particular, by changing the capacitance of the snubber capacitors 24a, 26a which are configured as variable capacitors.

A plurality of straight lines 82a, 84a, 86a, 88a, 90a, 92a which in each case identify an electrical efficiency of the supply unit are shown in the diagram of FIG. 3. The straight line 82a corresponds to an efficiency of 50%, i.e. in the region above the straight line 82a at least half of the electrical power used for operating the inverter unit 20a is lost as power loss. The straight line 84a corresponds to an efficiency of 80%, i.e. in a region below the straight line 84a at least 80% of the power used for operating the inverter unit 20a can be utilized. The straight line 86a corresponds to an efficiency of 90%, the straight line 88a corresponds to an efficiency of 92.5%, the straight line 90a corresponds to an efficiency of 95% and the straight line 92a corresponds to an efficiency of 97.5%. As can be derived from the diagram of FIG. 3 the induction energy supply device 10a can be operated very efficiently for high target powers of the positioned unit 16a when the snubber unit 22a is set in the second level 46a. Efficiencies of 95% or more can be achieved for target powers from ca. 2000 watts. For small target powers of the positioned unit 16a of up to 500 watts, however, there is a relatively low efficiency when the snubber unit 22a is set in the second level 46a, whereas when the snubber unit 22a is set in the first level 44a the efficiency is significantly greater for small target powers. In the operating state, the control unit 32a thus preferably sets the snubber unit 22a in the first level 44a for low target powers of up to 500 watts, and preferably in the second level 46a for medium to high powers from ca. 500 watts.

FIG. 4 shows a schematic diagram for illustrating a method for operating the induction energy supply device 10a. In the method, in an operating state of the induction energy supply device 10a at least the operating parameter 36a of the positioned unit 16a is wirelessly received by the data reception element 34a and a setting of the snubber unit 22a is adjusted on the basis of the operating parameter 36a. The method comprises at least two method steps 72a, 74a. In one method step 72a, in the operating state the operating parameter 36a of the positioned unit 16a is wirelessly received by the data reception element 34a. In a further method step 74a, the operating parameter 36a is processed by the control unit 32a and then a setting of the snubber unit 22a is adjusted on the basis of the operating parameter 36a.

In FIG. 5 a further exemplary embodiment of the invention is shown. The following descriptions are substantially limited to the differences between the exemplary embodiments, wherein relative to components, features and functions remaining the same, reference can be made to the description of the exemplary embodiment of FIGS. 1 to 4. For differentiating between the exemplary embodiments, the letter a is replaced in the reference signs of the exemplary embodiment in FIGS. 1 to 4 with the letter b in the reference signs of the exemplary embodiment in FIG. 5. Relative to components denoted the same, in particular relative to components having the same reference signs, in principle reference can also be made to the drawings and/or the description of the exemplary embodiment of FIGS. 1 to 4.

FIG. 5 shows a further exemplary embodiment of an induction energy transmission system 50b in a schematic view.

The induction energy transmission system 50b has a positioned unit 16b. The positioned unit 16b is configured as a small household appliance 52b and namely as a food processor. The induction energy transmission system 50b has at least one further positioned unit 18b. In contrast to the above exemplary embodiment, the positioned unit 18b is configured as an item of cookware 56b.

The induction energy transmission system 50b has a positioning plate 48b for positioning the positioned unit 16b and the further positioned unit 18b. In contrast to the above exemplary embodiment, the positioning plate 48b is configured as a kitchen countertop 94b.

The induction energy transmission system 50b has an induction energy supply device 10b comprising a supply unit 12b. The supply unit 12b has at least one supplying induction element 14b for inductively providing energy to the positioned unit 16b and/or the further positioned unit 18b. In the present case, the supply unit 12b has exactly two supplying induction elements 14b, wherein any other number might be conceivable.

The induction energy supply device 10b comprises an inverter unit (not shown) and a snubber unit (not shown) which is allocated to the inverter unit and includes a plurality of snubber capacitors (not shown). The induction energy supply device 10b has a control unit 32b for controlling the inverter unit. The control unit 32b has a data reception element 34b for wireless reception of at least one operating parameter (not shown) of the positioned unit 16b and is intended to adjust a setting of the snubber unit on the basis of the operating parameter. Regarding a construction of the snubber unit and a mode of operation of a setting of the snubber unit by the control unit 32b, reference can be made to the above description of the exemplary embodiment of FIGS. 1 to 4.

### REFERENCE SIGNS

10 Induction energy supply device
12 Supply unit
14 Supplying induction element
16 Positioned unit
18 Further positioned unit
20 Inverter unit
22 Snubber unit
24 Snubber capacitor
26 Snubber capacitor
28 Snubber capacitor
30 Snubber capacitor
32 Control unit
34 Data reception element
36 Operating parameter
38 Measuring unit
40 Further operating parameter
42 Switching element
44 First level
46 Second level
48 Positioning plate
50 Induction energy transmission system
52 Small household appliance
54 Further small household appliance
56 Item of cookware
58 Cooktop plate
60 Inverter switching element
62 Inverter switching element
64 X-axis
66 Y-axis
68 Power curve
70 Power curve
72 Method step
74 Further method step
76 Data transmission element
78 Further data transmission element
80 Receiving induction element
82 Straight line
84 Straight line
86 Straight line
88 Straight line
90 Straight line
92 Straight line
94 Kitchen countertop

1-13. (canceled)

14. An induction energy supply device, comprising:
a supply unit comprising a supplying induction element designed to inductively provide energy to a positioned unit;
an inverter unit designed to operate the supplying induction element;
a snubber unit interacting with the inverter unit and comprising a plurality of snubber capacitors; and
a control unit designed to control the inverter unit and comprising a data reception element designed for wireless reception of an operating parameter from the positioned unit, said control unit designed to adjust a setting of the snubber unit based on the operating parameter.

15. The induction energy supply device of claim 14, wherein the operating parameter is a target power of the positioned unit.

16. The induction energy supply device of claim 14, further comprising a measuring unit designed to determine a further operating parameter of the positioned unit.

17. The induction energy supply device of claim 16, wherein the control unit is designed to consider the further operating parameter when setting the snubber unit.

18. The induction energy supply device of claim 14, wherein at least one of the plurality of snubber capacitors of the snubber unit is a variable capacitor.

19. The induction energy supply device of claim 14, wherein the snubber unit comprises a switching element designed to enable the control unit to switch at least one of the plurality of snubber capacitors on or off.

20. The induction energy supply device of claim 14, wherein the control unit is designed to set a total electrical capacitance of the snubber unit to at least two different levels within a value range of at least 0 nF and of at most 40 nF.

21. The induction energy supply device of claim 20, wherein the control unit is designed to set a total electrical capacitance of the snubber unit to a first one of at least two different levels, with the first one of at least two different levels having a value of at least 0 nF and of at most 20 nF.

22. The induction energy supply device of claim 21, wherein the control unit is designed to set the total electrical capacitance of the snubber unit to a second one of the at least two different levels, with the second one of at least two different levels having a value of at least 15 nF and of at most 40 nF.

23. An induction energy transmission system, comprising:
a positioned unit; and
an induction energy supply device comprising a supply unit which includes a supplying induction element designed to inductively provide energy to the positioned unit, an inverter unit designed to operate the supplying induction element, a snubber unit interacting with the inverter unit and comprising a plurality of snubber capacitors, and a control unit designed to control the inverter unit and comprising a data reception element designed for wireless reception of an operating parameter from the positioned unit, said control unit designed to adjust a setting of the snubber unit based on the operating parameter.

24. The induction energy transmission system of claim 23, further comprising a positioning plate arranged above the supply unit of the induction energy supply device for positioning the positioned unit.

25. The induction energy transmission system of claim 23, wherein the positioned unit is designed as a small household appliance.

26. The induction energy transmission system of claim 23, further comprising at least one further positioned unit designed as an item of cookware.

27. A method for operating an induction energy supply device, the method comprising:
inductively supplying energy to a positioned unit;
wirelessly receiving in an operating state an operating parameter of the positioned unit by a data reception element; and
adjusting a setting of a snubber unit of the induction energy supply device based on the operating parameter.

28. The method of claim 27, further comprising determining a further operating parameter of the positioned unit.

29. The method of claim 28, further comprising considering the further operating parameter when setting the snubber unit.

30. The method of claim 27, further comprising switching at least one of a plurality of snubber capacitors of the snubber unit on or off.

31. The method of claim 27, further comprising setting a total electrical capacitance of the snubber unit to at least two different levels within a value range of at least 0 nF and of at most 40 nF.

32. The method of claim 27, further comprising setting a total electrical capacitance of the snubber unit to a first one of at least two different levels, with the first one of at least two different levels having a value of at least 0 nF and of at most 20 nF.

33. The method of claim 32, further comprising setting the total electrical capacitance of the snubber unit to a second one of the at least two different levels, with the second one of at least two different levels having a value of at least 15 nF and of at most 40 nF.
